(19) United States
(12) Patent Application Publication
(10) Pub. No.: US 2009/0083586 A1
(43) Pub. Date: Mar. 26, 2009

(54) FAILURE MANAGEMENT DEVICE AND METHOD

(75) Inventors: Adrian F. Warner, Delafield, WI (US); Paul Lawrence Mullen, Waukesha, WI (US); Richard L. Frowein, Waukesha, WI (US)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/859,908

(22) Filed: Sep. 24, 2007

(51) Int. Cl. G06F 11/30

(52) U.S. Cl. 714/47; 714/E11.179

(57) ABSTRACT

A method and device for monitoring failures are disclosed herein. The monitoring device comprises an environmental event generator and a status-monitor. The environmental event generator generates an environmental trigger based on changes in an environmental factor, and the status-monitor monitors failure-status of plurality of elements in a system. The status-monitor is configured to change its operational profile based on the environmental trigger. The device further comprises a decision mechanism configured to link the changes in an environmental factor and associated failure modes to different service industries.

### FIELD OF THE INVENTION

The present invention relates generally to a failure management device and method. More particularly, this invention relates to a failure monitoring device and method for monitoring failures of a system due to changes in an environmental factor.

### BACKGROUND OF THE INVENTION

Changes in environmental factors may affect sensitive electronic or other equipment. For example, changes in environmental factors may disturb the utility supply (e.g., water, electricity, natural gas, etc.) to equipment, operational conditions in which equipment operates, etc. Typical examples of environmental factors that may affect equipment include water ingress, floods, humidity, temperature, wind, hurricanes, tornados, earthquakes, solar flares or lightening. Some of these changes in environmental factors occur with some warning, and may be predicted/detected using various informational sources while others may occur without warning, or very limited warning. These changes in environmental factors can stress critical subsystems, physically displacing sensitive mechanisms, stressing electrical components resulting in loss of calibration, immediate failure, or incipient failures that resolve in an accelerated manner in the hours, day or weeks after the event. Similarly natural disasters due to environmental changes can strike quickly and without any warning and a quick and well-reasoned response to the emergency situation is critical in preserving life and health.

Further, upon changes in environmental factors, some of the critical parameters of a system may deviate from their initial set values. For example, the calibration of a measuring unit may deviate based on a temperature change in its environment. In such situations, it can be essential to monitor the effect of changes in an environmental factor and take necessary corrective action for the proper working of the system, such as by recalibrating the aforesaid measuring unit.

Some of the existing techniques for handling changes in environmental factors include monitoring the system or subsystems for failures. However the cost of monitoring may be high and may relate to economic, technical, capacity, or other resource-related factors. Yet another set of costs involved with monitoring devices are opportunity cost depending on the frequency of chances of a failure occurring and remediation cost. It may not be feasible to use a monitoring system continuously as the cost of the monitoring devices can be a major factor. To reduce the effective cost, one can optimize the usage of the monitoring devices. One way to optimize the usage of the monitoring devices is to control the usage of the monitoring devices based on the need or requirement. Thus it would be beneficial to provide a system or method to optimize the usage of the monitoring devices based on the situation or application.

Further, some of the existing techniques for monitoring the system or subsystems for failures based on a monitored status operate by disconnecting or disabling the system or subsystem. They shut-off the system in response to a simple fault condition in the system. However the shutting-off the whole system or subsystem may not always be required and may worsen the situation. Also the corrective action is taken after the failure has already occurred and been identified, which can result in an unacceptably large down time of the system.

It would be beneficial to identify possible failure-modes of a system as early as possible and thus there exists a need to provide a method and system for monitoring and managing failures of a system caused due to changes in an environmental factor.

### SUMMARY OF THE INVENTION

The above-mentioned shortcomings, disadvantages and problems are addressed herein which will be understood by reading and understanding the following specification.

One embodiment of the present invention provides a failure-monitoring device. The device comprises: an environmental event generator configured to generate an environmental trigger based on changes in an environmental factor; and a status-monitor connected to the environmental event generator, for monitoring failure-status of plurality of elements in a system. The status-monitor is configured to change its operational profile based on the environmental trigger. The environmental event generator includes an environmental event detector configured to generate an environmental trigger upon detection of changes in an environmental factor. The environmental event generator may also include an environmental event predictor configured to generate an environmental trigger upon prediction of an environmental event based on changes in an environmental factor.

In another embodiment, a failure monitoring method is disclosed. The method comprises: generating an environmental trigger, reflecting the changes in environmental factors; changing operation profile of a status-monitor based on the environmental trigger; and identifying failure-status of plurality of elements in a system using the status-monitor. The step of changing operational profile includes triggering the status-monitor for monitoring the failure-status of the elements. The step of changing operational profile may further include altering the monitoring frequency or nature of monitoring of the status-monitor.

In yet another embodiment, a failure management device is disclosed. The device comprises: an environmental event generator configured to generate an environmental trigger reflecting changes in an environmental factor; and a status-monitor connected to the environmental event generator, for monitoring failure-status of plurality of elements in a system, based on the environmental trigger. The system further includes a decision mechanism configured to initiate a plurality of services based on inputs from the environmental event generator and the status-monitor. The decision mechanism may be configured to control the elements in the system based on the effect of changes in the environmental factors.

In yet another embodiment, a failure management method is disclosed. The method comprises: initiating a decision mechanism to initiate maintenance services of a system based on an environmental action, wherein the environmental action reflects changes in an environmental factor.

Various other features, objects, and advantages of the invention will be made apparent to those skilled in the art from the accompanying drawings and detailed description thereof.

### BRIEF DESCRIPTION OF THE DRAWINGS

FIG. 1 is a block diagram of a failure monitoring device as described in an embodiment of the invention;

FIG. 2 is a detailed block diagram of a failure monitoring device as described in an embodiment of the invention;

FIG. 3 is a flowchart illustrating a method of monitoring failures as described in an embodiment of the invention; and

FIG. 4 is a block diagram of a failure management device as described in an embodiment of the invention.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

In various embodiments a failure monitoring method and device are disclosed. An environmental trigger is generated based on a change in an environmental factor and, based on the environmental trigger, one or more elements of a system are monitored for failures.

In various embodiments, a failure management device and method are disclosed. In one aspect of the method, the effect of changes in environmental factors in a system is linked with different service mediums. Also proactive service could be offered based on a detected environmental change and/or a predicted environmental event due to changes in environmental factors.

In an embodiment, a status-monitor, which monitors failure-status of elements in a system, is configured to change its operational profile based on changes in an environmental factor. This will allow the effective detection of failures and identification of early failures of the system and result in accelerated remediation relative to the damage incurred earlier.

In an embodiment, changes in environmental factors that affect a system or subsystem of the system are tracked. The frequency of the tracking can be altered based on the changes in environmental factors. Also based on the tracked changes in environmental factors, a set of failure modes of the system can be predicted. Based on the predicted failure modes, desired services can be availed.

In an embodiment, the invention links changes in an environmental factor to utility services. The changes in an environmental factor are used as a trigger to initiate utility services, which could be linked with different services required to attend different failure-modes caused by changes in environmental factors. By using the environmental trigger, services can be tailored to the product/system on behalf of the consumer to help restore service, or minimize potential downtime through capture of premature failure mechanisms before they are fully evolved. Where performance has been impaired, it is possible that this may also be detected allowing the product/system to be quarantined, preventing potential compromised operational use.

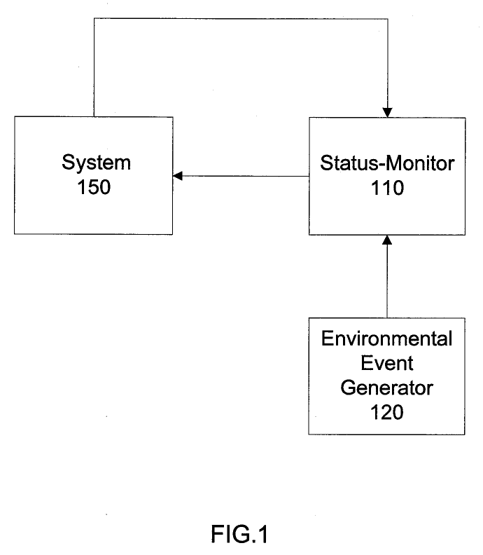

FIG. 1 illustrates a failure-monitoring device as described in an embodiment of the invention. The failure-monitoring device includes a status-monitor 110 and an environmental event generator 120. The failure-monitoring device is associated with a system 150, which has sensitive subsystems or elements, the performance of which could be affected by changes in one or more environmental factors. The status-monitor 110 is associated with the system or subsystem, which needs to be monitored and protected from the effect of changes in environmental factors. The status-monitor 110 may include a plurality of status monitoring elements associated with different elements of the system 150. For example, in the case of a communication system, status monitoring elements such as sensors could be associated with agents, routers, communication devices, interfaces etc. Each status monitoring element may be based on the nature of the elements/subsystems to which it is associated. The status-monitor is configured to identify the failure-status of the system to which it is attached. The failure-status could indicate the performance condition or status of the system. For example, lightening or electrical discharge might be associated with power function subsystems of the system 150, and an earthquake might affect the image quality of an imaging system.

In an embodiment, the status-monitor 110 is configured to monitor the system 150 for its failure-status such as power supply failure, service disruption, calibration changes, subsystem failures, etc., but the examples need not be limited to these. The statues-monitor 110 could include hardware or software status-monitors. The operational profile of the status-monitor 110 is configured to alter based on changes in the environmental factors.

The status-monitor 110 is connected with the environmental event generator 120. The environmental event generator 120 is configured to identify changes in one or more environmental factors and, based on the changes, to generate an environmental trigger applied to the status-monitor 110. The environmental trigger is used to change the operational profile of the status-monitor 110. The changes in environmental factors might include changes in water ingress, floods, humidity, temperature, wind, hurricanes, tornados, earthquakes, solar flares, lightening, etc., but need not be limited to these. In an example, the environmental trigger could be from an automated environmental event generator that receives information about changes in environmental factors in the form of e-mail, letter or Short Message Service (SMS).

In an embodiment, the environmental trigger is used to trigger the operation of the status-monitor 110. For example, in a system, the status-monitors provided could be activated upon detection of changes in environmental factors or prediction of an environmental event due to changes in environmental factors. The changes in environmental factors create an environmental trigger, which is used to trigger the status-monitor. This will allow the optimal use of the status-monitor. For example, if a status-monitor is configured to notice the status of a system in the event of an earthquake, the status-monitor need not be active always as the chances of occurrence of an earthquake may be low. Once the environmental event generator detects or predicts an earthquake, however, the status-monitor could be activated and could start monitoring the system.

In an embodiment, the status monitor 110 may be monitoring the system in a pre-defined manner. The environmental trigger from environmental event generator 120 is used to alter the monitoring frequency and nature of monitoring. For example, when an electrical storm is predicted, the monitoring frequency can be increased. If lightening strikes in the vicinity of the system 150, the nature of monitoring could be changed to a very high level unless the threat of transient-caused equipment downtime is reduced to an acceptable level. Also based on the nature of the detected changes in an environmental factor, a desired status-monitor could be selected. If the temperature in the vicinity of the system 150 is increased, status-monitors such as temperature sensors are activated.

In one embodiment, the environmental trigger controls the monitoring frequency and nature of monitoring. The environmental event generator 120 monitors the changes in the environmental factors and, based on the changes, generates the environmental trigger. The environmental event generator continues to monitor the changes in the environmental factors and once the environmental status returns to normal, the environmental event trigger is no longer generated or the environmental trigger generated conveys the fact that the environmental factors have returned to the normal condition. Based on the same the monitoring frequency and nature of monitoring can be returned to the initial level and the status-monitors can return to the initial operational profile. Thus optimization of monitoring process is achieved.

In an embodiment, the status-monitor 110 is provided with a database configured to store different types of environmental triggers and corresponding possible system failure-modes. Also the database can be configured to store different failure modes associated with different elements/sub systems of the system 150, the services required etc. Thus, once the environmental trigger is received by the status-monitor 110, the status-monitor 110 is able to identify possible failure modes and can define the monitoring strategy accordingly. For example, if the environmental trigger indicates water ingress, the status-monitor could check the elements of the system 150 that could be affected by water ingress and also could activate status monitoring elements which could detect the effect of water ingress. Further early speculation of failure will allow initiating the service quickly. For example, in the case of catastrophic electrical damage, knowledge of the product failure mechanisms would allow speculative, expedited shipment of potential failed parts simultaneous with the dispatch of service personnel. Also the database may be updated upon detection of additional failure modes or identification of a different solution.

In various embodiments, the environmental event generator 120 could be an environmental event detector and/or an environmental error predictor. The environmental event detector detects an environmental change and accordingly generates an environmental trigger. For example, in case of a chemical spill or electrical storm, the detector initially detects this event and then generates an environmental trigger. On the other hand, the environmental event predictor could predict some environmental events based on changes in environmental factors. This will be helpful in taking proactive measures. For example a hurricane could be predicted by noticing some changes in the environment and the status-monitor could change its operation profile based on the environmental trigger. Further, based on changes in environmental factors, the failure modes could be predicated in advance, so that corrective action can be taken to prevent the failure or to reduce the impact of failure or to reduce the down time of the system.

Additionally, the predictive monitoring of environmental challenges may allow the operating organization to take preventive actions to avoid significant damage. For example, a local utility company may disconnect or temporarily suspend services to the system 150 when lightening is predicted. Similarly, in the case of severe weather where structural damage is a possibility, the service offered may for example include emergency re-commissioning services, and/or onsite mobile services to support operational needs post event. In these ways, by using a combination of predictive event and flexible response services, a customer may afford additional protection to capital equipment to minimize potential downtime.

Thus the environmental event generator 120 can be configured to trigger the status-monitor 110. The status-monitor 110 analyzes the status of the system 150 and provides the status information to a decision mechanism. The decision mechanism is configured to take various decisions based on the input. For example, the decision mechanism is configured to be a service provider, which could provide utility services based on the need.

In an embodiment an automated failure monitoring device is disclosed. The environmental event generator 120 monitors the changes in environmental factors and generates an environmental trigger based on changes in the environmental factors. The status-monitor 110 monitors the failure-status of the system 150. The environmental trigger triggers the operation of the status-monitor 110, facilitating automatic operation of the status-monitor 110 without human intervention. Once the failure-status is identified, it could trigger a decision mechanism to initiate various services. Also the status-monitor 110 could display the failure-status of the system 150 and based on that an operator could request a desired service.

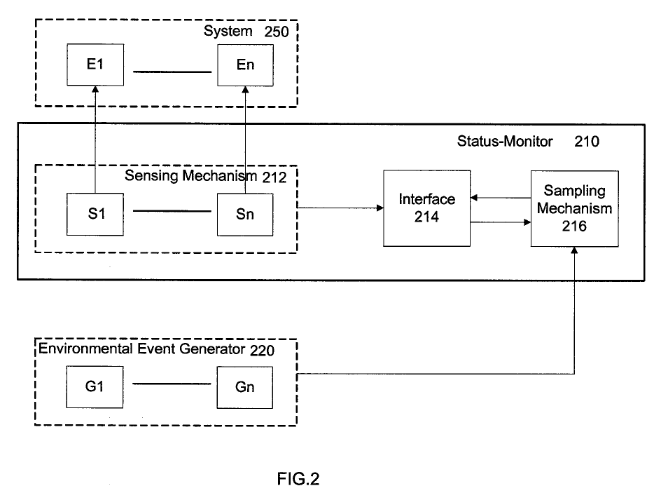

FIG. 2 is a detailed view of a failure-monitoring device as described in an embodiment of the invention. The failure-monitoring device is provided with a status-monitor 210 and an environmental event generator 220. The status-monitor 210 is associated with a system 250 whose failure-status needs to be monitored. The system 250 includes a plurality of elements or subsystems E1 to En. Each element might be performing different functions and the effect of changes in environmental factors might be different on each element. The status-monitor 210 is configured to have a sensing device 212, an interface 214 and a sampling mechanism 216. The sensing device 212 includes a plurality of sensors S1 to Sn. Each sensor is associated with one or more elements E1 to En in the system 250. The nature of the sensors S1 to Sn depends on the elements E1 to En to which they are associated and possible failure modes that could occur due to changes in environmental factors. Different combinations and arrangements of sensors and elements are possible and need not be limited to the illustrated one. The sensing device 212 will monitor different elements/subsystems of the system 250 such as power supply voltage, service disruption, re-boot, disc fragmentation and so forth. The sensing device 212 will sense different parameters from the system 250 and the sensor interface 214 will provide the sensor output to the sampling mechanism 216. The sensor interface 214 could be hardware and/or software interfaces that act as a mediator between the sampling mechanism 216 and the sensing device 212. The sampling mechanism 216 decides the frequency of sampling or monitoring. The monitoring could be done continuously, randomly or in a predefined interval. The sampling mechanism 216 may trigger the sensing device 212 to start monitoring the elements E1 to En. The interface 214 acts as an interface between the sensor device 212 and the sampling mechanism 216. The interface 214 will also facilitate specific scrutiny of the elements E1 to En based on knowledge of typical failure modes associated with the type of environmental trigger and to coordinate different forms of input from different sensors to a single sampling mechanism 216. Also the interface 214 communicates various information such as activation information, sampling frequency information etc from the sampling mechanism 216 to sensing device 212. The environmental event generator 220 is configured to generate an environment trigger based on the changes in environmental factors. The environmental event generator 220 may include environmental event generators G1 to Gn for generating different forms of environmental triggers. The environmental event generator 220 may include a receiver to receive an e-mail or letter indicating the changes in an environmental factor. It may also include automatic event generators that are configured to monitor various changes in environmental factors continuously and to generate environmental triggers in real time. The environmental trigger triggers the sampling mechanism 216 and changes its operational profile. If a change in environmental factor is detected or an environmental event is predicted based on the change in environmental factor, the sampling frequency of the sampling mechanism 216 may be increased and in effect the system 250 will be monitored more closely.

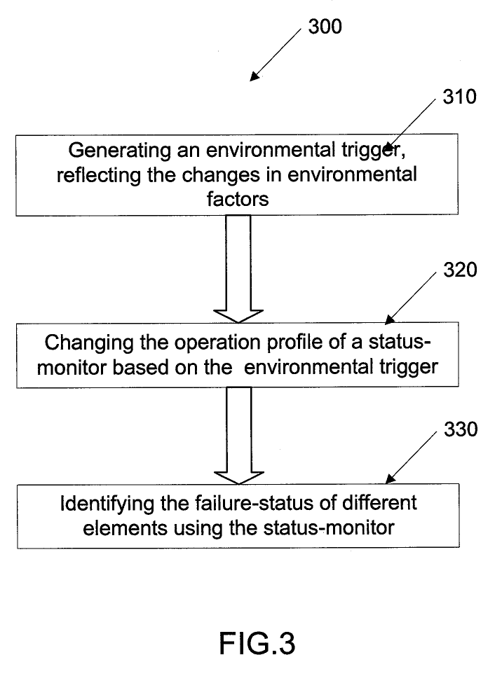

FIG. 3 is a flowchart illustrating a method of failure monitoring as described in an embodiment of the invention. In an embodiment the failure monitoring method 300 monitors the effect of changes in environmental factors on various elements in a system. At step 310, an environmental trigger is generated based on a change in one or more environmental factors. An environmental trigger generator could be configured to generate an environmental trigger. The environmental trigger indicates the changes in environmental factors or the probability of occurring an environmental event due to changes in environmental factors. At step 320, the environmental trigger is used to alter the operational profile of a status-monitor. The environmental trigger triggers the status-monitor or changes the monitoring parameters such as monitoring frequency, nature of monitoring etc. The status-monitor is associated with a plurality of elements in a system, which is sensitive and could be affected by the changes in an environmental factor. At step 330, the status-monitor identifies the failure-status of the plurality of elements. The failure-status includes performance or operation condition of elements and the effect of changes in environmental factors on the elements. The environmental trigger may further be used to trigger a decision mechanism configured to provide different services such shutting down of the system, ordering replacement, calling a service person, etc.

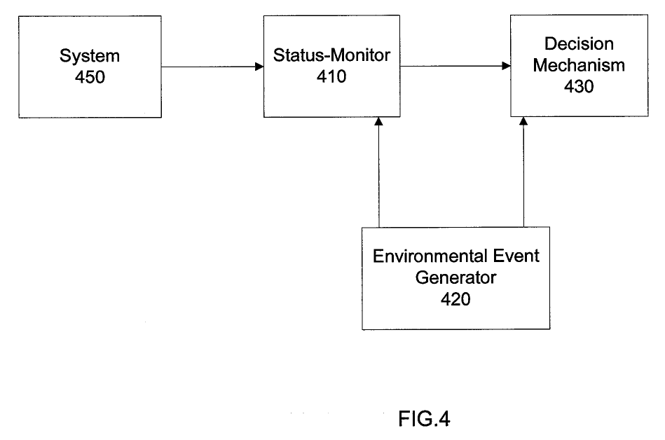

FIG. 4 is block diagram of a failure management device as described in an embodiment of the invention. The failure management device is associated with a system 450 having a plurality of elements, which are sensitive to changes in environmental factors. The failure management device is provided with a status-monitor 410, an environmental event generator 420 and a decision mechanism 430. The status-monitor 410 monitors the failure-status of the elements in the system 450. The environmental event generator 420 is configured to generate an environmental trigger based on the changes in environmental factors. The environmental trigger could be generated upon detection of changes in environmental factors or upon prediction of an environmental event due to changes in environmental factors. The status-monitor 410 is configured to change its operational profile based on the environmental trigger.

If the environmental trigger occurs as a detected event, it results in increased monitoring of the system under service protection. The monitoring process is used to extract key system markers such as power supply voltage, service disruption, re-boot, disc fragmentation and so forth. In addition the monitoring may also facilitate specific scrutiny based on knowledge of typical failure modes associated with the type of environmental trigger, for example lightening or electrical discharge might be associated with power function subsystems, whereas earthquake might for example be directed at image quality based on image subsystem potential for misalignment. Thus, using knowledge of possible failure modes relative to the environmental trigger, allows the service actions to be focused on specific areas of potential negative impact. Comparing pre-event, monitoring process continuous to confirm damage, or evolving failure. Further, linking the failure mode to potential replacement part, and/or to a service action can expedite return to normal service through early shipment of part to the customer, and synchronizing the attendance by a field service engineer such that replacement occurs before hard down failure has occurred.

In an embodiment the environmental trigger is configured to control the operation of the status-monitor. Once the environmental trigger is received by the status-monitor, based on the type or nature of the environmental trigger, the nature and frequency of status monitoring is changed. The environmental event generator generates the environmental trigger unless there is a change in one of the environmental factors and once the environmental factors returns to the normal condition, the environmental trigger is not generated and the status-monitor may return to its initial operational profile.

In an embodiment, an environmental monitoring technician can create a request for service manually into an existent remote service system, on receipt of an environmental trigger. This environmental trigger could be observation of weather conditions for a specific area, or an email from a weather service advising of adverse conditions. This method is applicable to any other kind of environmental event. The request for service, can simply request to a remote on-line engineer to periodically monitor the system under service contract, or specifically investigate a function and subsystems impacted by the reported condition.

In an embodiment the decision mechanism is connected with the environmental event generator. The environmental trigger electronically initiates the service action through the decision mechanism. The monitoring can take place automatically, using encoded knowledge of failures modes to logically check the system elements for failure signs. This concept may be further extended using advanced knowledge of failure concepts to look for emergent failure signatures of evolving failure.

Upon receiving the environmental trigger, the decision mechanism may predict possible failure modes of the system and may take necessary action to prevent the failure or to decrease the downtime of the elements or system affected by the changes in environmental factors.

In an embodiment the decision mechanism could receive input from any source about the environmental changes such as an e-mail or SMS sent to the decision mechanism and accordingly the decision mechanism can take appropriate corrective or preventive action.

In an embodiment a decision mechanism is connected with the status-monitor, based on the monitored failure-status the decision mechanism can initiate different services.

In an embodiment the environmental event generator is configured to predict an environmental event such as a hurricane, earthquake, etc. and may convey this information to the decision mechanism. The decision mechanism based the environment trigger could take appropriate corrective action. Also the status-monitor could predict some failure modes in accordance with the environmental trigger and this information could be used by the decision mechanism to proactively initiate services.

In an embodiment the invention uses an externally derived environmental event trigger to initiate the service function. This event trigger may be derived from public disseminated knowledge, i.e. hurricane predictions, NOAA weather service, earthquake detection systems, or dedicated weather services. An example of a dedicated weather service is “Accuweather”. In the case of the “Accuweather”, the company provides a series of lightening detection and prediction services. Their service highlights that detection may be either reactive, or predictive and the invention disclosed may be applied to either case. Accordingly, when an environmental event occurs, a service system is triggered. The trigger occurs as a detected event, which results in increased monitoring of device log files of the device under service protection. These device log files can be used to extract key system markers such as power supply voltage, service disruption, re-boot, disc fragmentation and so forth. In addition the device log files may also be subject to specific scrutiny based on knowledge of typical failure modes associated with the type of environmental trigger, for example lightening might be associated with power function subsystems, whereas earthquake might for example be directed at image quality based on image subsystem potential for misalignment. Thus, using knowledge of possible failure modes relative to the environmental trigger, allows the service actions to be focused on specific areas of potential negative impact. Comparing pre-event, and post event markers derived from the log files may then confirm damage, or evolving failure. Further, linking the failure mode to potential replacement part, and/or service action can expedite return to normal service through early shipment of part to the customer, and synch-up the attendance by a field service engineer such that replacement occurs before hard down failure has occurred.

In another embodiment the environmental event generator is configured to define the probability of the need for a service action based on different factors such a severity of an environmental event. For example based on hurricane or tornado wind speed, lightening energy density function, or earthquake magnitude in “Richter scale”, etc. may define the severity of the environmental event. The decision mechanism, using this information, geographic proximity, combined with basic system response, may determine whether the system under service has suffered catastrophic damage. This might be linked to an enhanced service/insurance contract to provide services, for example emergency mobile services. Alternatively, the information may be combined with the decision mechanism to select possible service actions. For example, in the case of an earthquake over a certain magnitude, initiation of service action may be automatic—for example instrument optics “will need recalibration”, or close down of the system is required because critical subsystems have failed, or will fail if not done.

In another embodiment, it is highly likely that new failure modes are discovered in the process of monitoring environmental triggered failures, in the course of providing this sort of service to customers. Thus to extend the effectiveness of the coverage provided, a field service or on-line engineer may feedback this information to a service organization. This information could be used to create a database with different failure modes and the solutions offered for each failure modes. Further a knowledge response logic used to detect these additional failure modes is also identified and stored. The database may also include identification of specific functional replacement units that may be required to restore system functionality with respect to different failure-modes. Thus through these efforts the knowledge discovered from new and emergent failure modes is formed into a database such that future events can be detected, and responded to in the most effective, and timely manner.

In an embodiment a fully automated failure management device is described. In the device, the environmental generator generates an environmental trigger and the status-monitor is triggered accordingly. The environmental trigger could also be fed to a decision mechanism and the decision mechanism could predict possible failure modes based on the environmental trigger, or could detect failure-status by receiving a signal from the status-monitor. The status-monitor could inform the decision mechanism about the monitored failure-status and based on that the decision mechanism could select desired services. This will minimize the human intervention in deciding the service required or the replacement of the parts during a disaster or system failure. If the failure of a part is predicted in advance, the replacement or service request can be placed before the customer is aware of the problem. This may help the system from failure or save the downtime of the system.

In an embodiment a failure management method is disclosed. The method comprises: initiating a decision mechanism to initiate maintenance services of a system based on an environmental action, the environmental action reflects changes in an environmental factor. The environmental action could be in the form of an environmental trigger, generated by an environmental event generator. The environmental trigger is generated based on the detected changes in the environmental factors or predicted environment event due to changes in the environmental factors. The environmental action could also be generated by a status-monitor that monitors the status of a system, which has plurality of elements sensitive to changes in environmental factors. The status-monitor is configured to monitor the system based on an environmental trigger, which reflects the changes in the environmental factors. Further the operational profile of the status-monitor could be configured to modify with the changes in environmental factors. Once the environmental action is detected, the decision mechanism is configured o initiate different services including shutting of the system or subsystems, calling a service personal, ordering spare parts etc.

Some of the advantages of the invention include the ability to predict failure or disaster of a system and linking this to different services such as servicing, replacing parts, shifting of parts etc. This will avoid the disaster or will facilitate a speedy disaster/failure recovery. The failure monitoring device could be automated to avail necessary services based on the changes in an environmental factor. This could facilitate automatic replacement part identification and dispatch. The status monitoring cost of the status-monitor is optimized as its profile is controlled by changes in the environmental factors. If there are no changes in the environment, the monitoring frequency could be kept low. Another advantage of the invention is reduction in down time which could be achieved by early failure detection, predictive damage analysis, predictive shipment of parts based on knowledge of event and consequences, early identification based on pre/post event analysis of system performance of evolving defects etc. Also identification of incipient failure modes based on type of event, and knowledge of damage consequences will facilitate reduction in down time of the system. Further the invention provides creation of specific environmental service response criteria and response levels based on contracted coverage and also the creation of specific environmental failure mode detection criteria. Yet another advantage of the invention is optimized usage of status-monitors. The status-monitors need not be used continuously and could be triggered based on requirements such as a change in the environmental factor. Thus the overall monitoring cost is reduced as the cost is adaptively controlled based on the presented risk.

Thus various embodiments of the invention describe method and system for failure management and failure monitoring, the failures being caused due the changes in environmental factors.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

We claim:

1. A failure monitoring device comprising:
an environmental event generator configured to generate an environmental trigger based on changes in an environmental factor; and
a status-monitor connected to the environmental event generator, for monitoring failure-status of plurality of elements in a system;
wherein the status-monitor is configured to change its operational profile based on the environmental trigger.

2. The device as in claim 1, wherein the environmental event generator includes an environmental event detector configured to generate an environmental trigger upon detection of changes in an environmental factor.

3. The device as in claim 1, wherein the environmental event generator includes an environmental event predictor configured to generate an environmental trigger upon prediction of an environmental event based on changes in an environmental factor.

4. The device as in claim 1, wherein the status-monitor triggers monitoring failure-status of the elements, based on the environmental trigger.

5. The device as in claim 1, wherein the status-monitor changes frequency and nature of failure-status monitoring based on the environmental trigger.

6. The device as in claim 1, further comprising a decision mechanism coupled to the environmental event generator and the status-monitor, configured to control the elements in the system.

7. A failure monitoring method comprising:
generating an environmental trigger, reflecting the changes in an environmental factor;
changing operation profile of a status-monitor based on the environmental trigger; and
identifying failure-status of plurality of elements in a system using the status-monitor.

8. A method as in claim 7, wherein the step of generating an environmental trigger comprises: generating the environmental trigger upon detection of changes in an environmental factor.

9. A method as in claim 7, wherein the step of generating an environmental trigger comprises: generating the environmental trigger upon prediction of an environmental event based on changes in an environmental factor.

10. A method as in claim 7, wherein the step of changing operational profile comprises: triggering the status-monitor for monitoring failure-status of the elements.

11. A method as in claim 10, wherein the step of changing operational profile further comprises: altering the monitoring frequency of the status-monitor.

12. A method as in claim 11, wherein the step of changing operational profile comprises: changing the nature of monitoring of the status-monitor.

13. A method as in claim 11, wherein the step of changing operational profile comprises: returning to the initial operational profile upon non-availability of the environmental trigger.

14. A method as in claim 7, wherein the step of identifying comprises: detecting failure of at least one element in the system.

15. A method as in claim 7, wherein the step of identifying comprises: predicting failure of at least one element in the system.

16. A method as in claim 7 further comprising, providing a failure detection model based on plurality of failure-status along with corresponding environmental events.

17. A failure management device comprising:
an environmental event generator configured to generate an environmental trigger reflecting changes in an environmental factor; and
a status-monitor connected to the environmental event generator, for monitoring failure-status of plurality of elements in a system, based on the environmental trigger;
a decision mechanism configured to initiate a plurality of services based on inputs from the environmental event generator and the status-monitor.

18. A system as in claim 16, wherein the status monitoring device is configured to change the operational profile based on the environmental trigger.

19. A system as in claim 17, wherein the decision mechanism is configured to control the elements in the system.

20. A system as in claim 18, wherein the decision mechanism is configured to enable and disable elements based on the environmental trigger.

21. A system as in claim 18, wherein the decision mechanism is configured to select available utility services based on the environmental trigger.

22. A system as in claim 18, wherein the decision mechanism is configured to predict the failure of a system based on the environmental trigger.

23. A system as in claim 18, wherein the decision mechanism is configured proactively avail services based on a predicted or detected environmental event.

24. A failure management method comprising:
initiating a decision mechanism to initiate maintenance services of a system, based on an environmental action, wherein the environmental action reflects changes in an environmental factor.

25. A method as in claim 24, wherein the environmental action includes generating an environmental trigger based on detection of changes in environmental factor and prediction of an environmental event based on the changes in an environmental factor.

26. A method as in claim 24, wherein the environmental action is generated based on failure-status of the system, the failure-status being predicted and detected based on the changes in an environmental factor.
